(19) United States
(12) Patent Application Publication
(10) Pub. No.: US 2021/0245557 A1
(43) Pub. Date: Aug. 12, 2021

(54) TIRE COMMUNICATION APPARATUS

(71) Applicants: Kabushiki Kaisha Toshiba, Tokyo (JP); Toshiba Electronic Devices & Storage Corporation, Tokyo (JP)

(72) Inventor: Koji Ito, Kamakura Kanagawa (JP)

(21) Appl. No.: 16/928,114

(22) Filed: Jul. 14, 2020

(30) Foreign Application Priority Data
Feb. 10, 2020 (JP) 2020-020334

(51) Int. Cl. B60C 23/02; G01M 17/02

(52) U.S. Cl. CPC B60C 23/02; G01M 17/02

(57) ABSTRACT

A tire communication apparatus of an embodiment includes a pressure sensor, a first wireless control unit and a second wireless control unit. The pressure sensor detects an air pressure of a tire. When receiving a wireless carrier sent out from a monitoring terminal by a first communication method, the first wireless control unit generates a trigger signal. The second wireless control unit is activated by the trigger signal being inputted when the second wireless control unit is stopped, acquires a detection result of the air pressure of the tire from the pressure sensor and transmits the detection result to the monitoring terminal by a second communication method different from the first communication method.

### CROSS-REFERENCE TO RELATED APPLICATION

This application is based upon and claims the benefit of priority from Japanese Patent Application No. 2020-020334, filed Feb. 10, 2020; the entire contents of which are incorporated herein by reference.

### FIELD

Embodiments described herein relate generally to a tire communication apparatus.

### BACKGROUND

Recently, vehicles have been equipped with a tire pressure monitoring system (TPMS) that monitors an air pressure of a tire and warns a driver when the air pressure of the tire significantly decreases. The TPMS is provided with a tire communication apparatus that measures an air pressure of a tire and performs wireless communication, and a control apparatus that receives information about the air pressure from the tire communication apparatus and gives a warning when the air pressure of the tire significantly decreases.

Further, recently, BLE (Bluetooth Low Energy) has been incorporated in various equipment, and BLE has been incorporated in the tire communication apparatus. When BLE is used for wireless communication of the TPMS, power consumption increases because BLE has to continue transmitting a beacon signal, for example, every few seconds.

In order to reduce the power consumption, it is conceivable to sufficiently lengthen the beacon signal transmission interval. However, for example, at the time of checking operation when the tire communication apparatus is newly attached to a tire or at the time of maintenance of a tire to which the tire communication apparatus is already attached, it takes time before communication is established if the beacon signal transmission interval is sufficiently long. Further, in order to further reduce the power consumption, it is necessary to terminate all communication and not to supply power to BLE or to perform control so that a clock is not inputted and stop BLE.

### BRIEF DESCRIPTION OF THE DRAWINGS

FIG. 1 is an external view showing a configuration of a tire communication system provided with a tire communication apparatus of a first embodiment;

FIG. 2 is a block diagram showing the configuration of the tire communication system provided with the tire communication apparatus of the first embodiment:

FIG. 3 is a diagram showing an example of a display screen of a monitoring terminal;

FIG. 4 is a circuit diagram showing a circuit configuration of a wireless wake-up control unit;

FIG. 5 is a flowchart showing a flow of a data transmission process in the tire communication apparatus of the first embodiment;

FIG. 6 is a block diagram showing a configuration of a tire communication system provided with a tire communication apparatus of a second embodiment; and

FIG. 7 is a flowchart showing a flow of a data transmission process in the tire communication apparatus of the second embodiment.

### DETAILED DESCRIPTION

Each of tire communication apparatuses of embodiments has a pressure sensor, a first wireless control unit and a second wireless control unit. The pressure sensor detects an air pressure of a tire. When receiving a wireless carrier sent out from a monitoring terminal by a first communication method, the first wireless control unit generates a trigger signal. The second wireless control unit is activated by the trigger signal being inputted when the second wireless control unit is stopped, acquires a detection result of the air pressure of the tire from the pressure sensor and transmits the detection result to the monitoring terminal by a second communication method different from the first communication method.

The embodiments will be described below in detail with reference to the drawings.

### First Embodiment

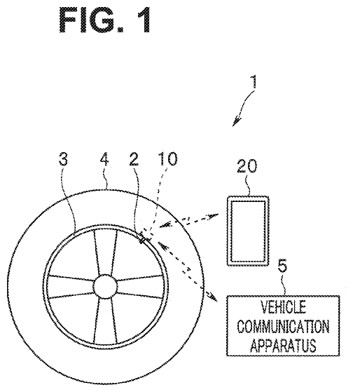

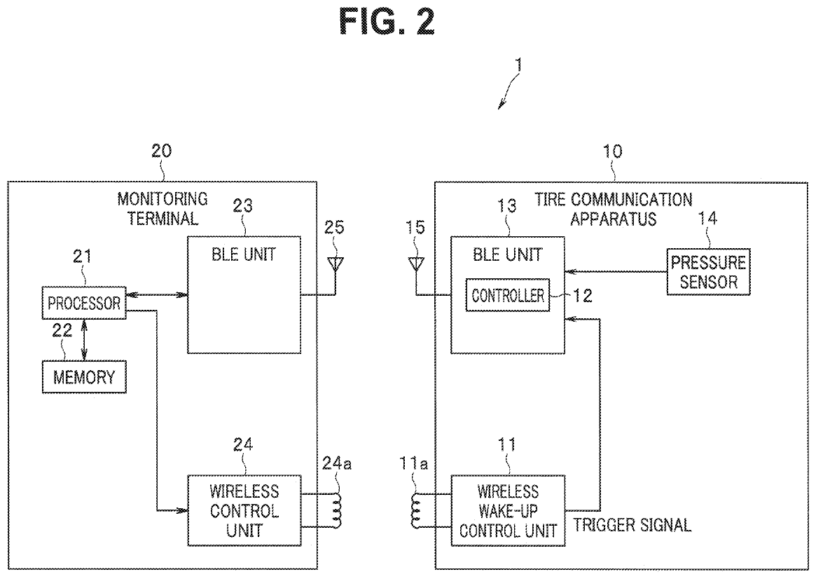

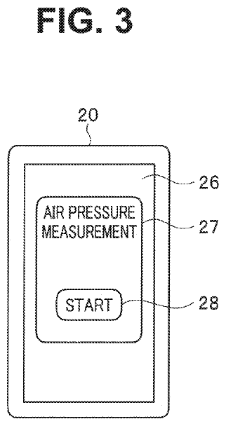

FIG. 1 is an external view showing a configuration of a tire communication system provided with a tire communication apparatus of a first embodiment; FIG. 2 is a block diagram showing the configuration of the tire communication system provided with the tire communication apparatus of the first embodiment; and FIG. 3 is a diagram showing an example of a display screen of a monitoring terminal.

A tire communication system 1 includes a vehicle communication apparatus 5, a tire communication apparatus 10 and a monitoring terminal 20.

The tire communication apparatus 10 is attached to a wheel 3 via a valve 2 and arranged inside a tire 4. The tire communication apparatus 10 measures an air pressure inside the tire 4 and transmits a measurement result to the monitoring terminal 20.

The monitoring terminal 20 is, for example, a mobile terminal such as a smartphone and a tablet, and the monitoring terminal 20 communicates with the tire communication apparatus 10 to receive the measurement result of the air pressure of the tire 4. A smartphone and a tablet are generally equipped with proximity wireless communication such as NFC (near field communication). In the present embodiment, at the time of causing the tire communication apparatus 10 to be activated, the tire communication apparatus 10 that is stopped is caused to be activated at an arbitrary timing by using proximity wireless communication such as NFC. Note that NFC refers to a communication protocol specified in ISO/JEC 18092 (NFC IP-1) or ISO/IEC 21481 (NFC IP-2).

The vehicle communication apparatus 5 is arranged at a predetermined position in a vehicle, and the vehicle communication apparatus 5 establishes BLE communication with the tire communication apparatus 10 when an engine of the vehicle is started, and traveling is started. When the BLE communication is established with the vehicle communication apparatus 5, the tire communication apparatus 10 transmits a measurement result of an air pressure of the tire 4 to the vehicle communication apparatus 5 at a predetermined time interval. When receiving the measurement result of the air pressure of the tire 4 from the tire communication apparatus 10 at the predetermined time interval, the vehicle communication apparatus 5 judges whether or not the air pressure of the tire 4 is equal to or below a threshold set in advance. If judging that the air pressure of the tire 4 is equal to or below the threshold set in advance, the vehicle communication apparatus 5 displays a warning on an instrument panel or a retrofitted indicator to notify a driver of an abnormality of the tire 4.

As shown in FIG. 2, the tire communication apparatus 10 is provided with a wireless wake-up control unit 11 provided with an antenna coil 11a, a BLE unit 13 provided with a controller 12, a pressure sensor 14 and an antenna 15.

The monitoring terminal 20 is provided with a processor 21, a memory 22, a BLE unit 23, a wireless control unit 24 provided with an antenna coil 24a, and an antenna 25.

The wireless wake-up control unit 11 constituting a first wireless control unit communicates with the monitoring terminal 20 by a first communication method. The first communication method is NFC communication. Further, the BLE unit 13 constituting a second wireless control unit communicates with the monitoring terminal 20 by a second communication method different from the first communication method. The second communication method is BLE communication. Note that the wireless wake-up control unit 11 and the BLE unit 13 are configured as a one-chip semiconductor device.

In the memory 22, an application program for air pressure measurement is stored. When a user executes the application program for air pressure measurement by operating the monitoring terminal 20, the processor 21 reads out the application program for air pressure measurement from the memory 22 and executes the application program for air pressure measurement.

When the application program for air pressure measurement is executed, an air pressure measurement screen 27 is displayed on a display unit 26 of the monitoring terminal 20 as shown in FIG. 3. The user can start air pressure measurement by pressing a start button 28 provided on the air pressure measurement screen 27.

When the start button 28 is pressed, the wireless control unit 24 sends out a necessary wireless carrier (for example, proximity wireless communication such as NFC) to the wireless wake-up control unit 11 of the tire communication apparatus 10 by the first communication method, under control of the processor 21. More specifically, the wireless control unit 24 causes a 13.56 MHz alternating current (AC) magnetic field to be generated by applying a desired clock signal to the antenna coil 24a. The user brings the monitoring terminal 20 close to the tire communication apparatus 10 in a state in which the wireless control unit 24 sends out the wireless carrier.

In the wireless wake-up control unit 11, when the wireless carrier sent out from the wireless control unit 24 is received, an AC voltage is generated on the antenna coil 11a. When the AC voltage is generated on the antenna coil 11a, the wireless wake-up control unit 11 generates a trigger signal for causing the BLE unit 13 that is stopped to be activated and outputs the trigger signal to the BLE unit 13. Note that a state in which the BLE unit 13 is stopped is a state in which power is not supplied to the BLE unit 13 or a clock is not inputted. When the engine of the vehicle is stopped, the BLE unit 13 is in the stopped state. When the engine of the vehicle is running, the BLE unit 13 is in an activated state.

When the trigger signal is inputted when the BLE unit 13 is in the stopped state, the controller 12 of the BLE unit 13 activates the BLE unit 13 that is stopped, and transmits a signal for communication establishment, more specifically, an advertising packet via the antenna 15 at a predetermined interval by the second communication method (BLE).

When receiving the advertising packet via the antenna 25, the BLE unit 23 of the monitoring terminal 20 returns a connection request to the tire communication apparatus 10. Thereby, communication by the second communication method is established between the tire communication apparatus 10 and the monitoring terminal 20. When the communication is established between the tire communication apparatus 10 and the monitoring terminal 20, the controller 12 of the BLE unit 13 acquires a detection result detected by the pressure sensor 14 (information about an air pressure of the tire 4) and transmits the detection result to the monitoring terminal 20. Furthermore, the controller 12 transmits information about a type, proper pressure, characteristics and the like of the tire 4 to the monitoring terminal 20 together with the information about the air pressure of the tire 4.

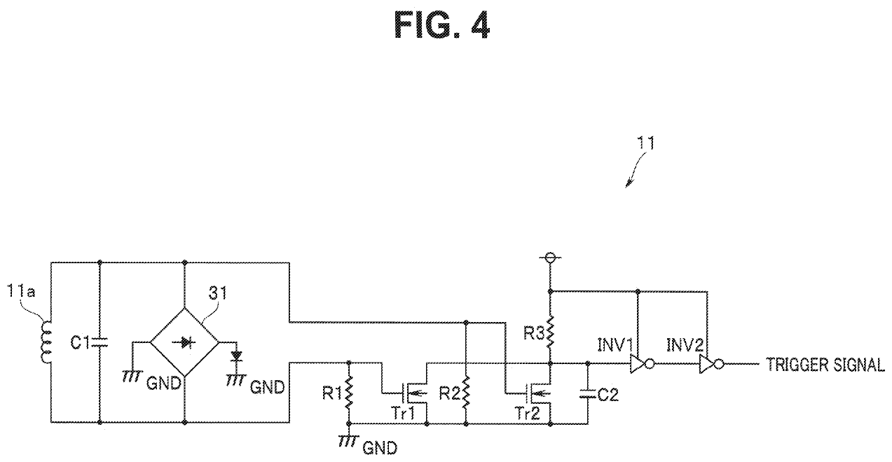

Here, a configuration of the wireless wake-up control unit 11 configured to receive a wireless carrier and output a trigger signal will be described. FIG. 4 is a circuit diagram showing a circuit configuration of a wireless wake-up control unit.

An antenna is configured with a capacitor C1 connected in parallel with the antenna coil 11a. An output terminal on one end of the antenna coil 11a is connected to an input terminal on one end of a rectifier circuit 31 and is connected to a gate terminal of a transistor Tr1. Further, the output terminal on the one end of the antenna coil 11a is connected to a GND via a resistance R1.

An output terminal on the other end of the antenna coil 11a is connected to an input terminal on the other end of the rectifier circuit 31 and is connected to a gate terminal of a transistor Tr2. Further, an output terminal on the other end of the antenna coil 11a is connected to the GND via a resistance R2. An output terminal of the rectifier circuit 31 is connected to the GND.

The transistors Tr1 and Tr2 and a capacitor C2 are connected in parallel. Drain terminals of the transistors Tr1 and Tr2 and one terminal of the capacitor C2 are connected to a power source via a resistance R3. Further, source terminals of the transistors Tr1 and Tr2 and the other terminal of the capacitor C2 are connected to the GND.

Inverter circuits INV1 and INV2 are connected in series, and an input terminal of the inverter circuit INV1 and one terminal of the capacitor C2 are connected. Electric charge is accumulated in the capacitor C2 by the power source, and an H-level signal is inputted to the input terminal of the inverter circuit INV1.

When the monitoring terminal 20 is not close to the tire communication apparatus 10, electric charge is accumulated in the capacitor C2 by the power source, and an H-level signal is inputted to the inverter circuit INV1. The inverter circuit INV1 inverts the inputted H-level signal and outputs an L-level signal to the inverter circuit INV2. The inverter circuit INV2 inverts the inputted L-level signal and outputs an H-level signal to the BLE unit 13 as a trigger signal. In other words, when the monitoring terminal 20 is not close to the tire communication apparatus 10, an H-level signal is inputted to the BLE unit 13 as a trigger signal.

On the other hand, when the monitoring terminal 20 is brought close to the tire communication apparatus 10, a wireless carrier is received by the antenna coil 11a by the first communication method (NFC communication), and an AC voltage is generated. The AC voltage that is generated on the antenna coil 11a is inputted to the gate terminals of the transistors Tr1 and Tr2 as switching elements. Thereby, the transistors Tr1 and Tr2 connected in parallel with the capacitor C2 repeat on/off, and the electric charge accumulated in the capacitor C2 is released to the GND (a reference potential).

As a result, an L-level signal is inputted to the inverter circuit INV1 from the capacitor C2. The inverter circuit INV1 inverts the inputted L-level signal and outputs an H-level signal to the inverter circuit INV2. The inverter circuit INV2 inverts the inputted H-level signal and outputs an L-level signal to the BLE unit 13 as a trigger signal. In other words, when the monitoring terminal 20 is brought close to the tire communication apparatus 10, an L-level signal is inputted to the BLE unit 13 as a trigger signal.

Thus, when the monitoring terminal 20 is brought close to the tire communication apparatus 10, a trigger signal changes from the H level to the L level. When detecting that the trigger signal from the wireless wake-up control unit 11 changes from the H level to the L level, the controller 12 activates the BLE unit 13 that is stopped.

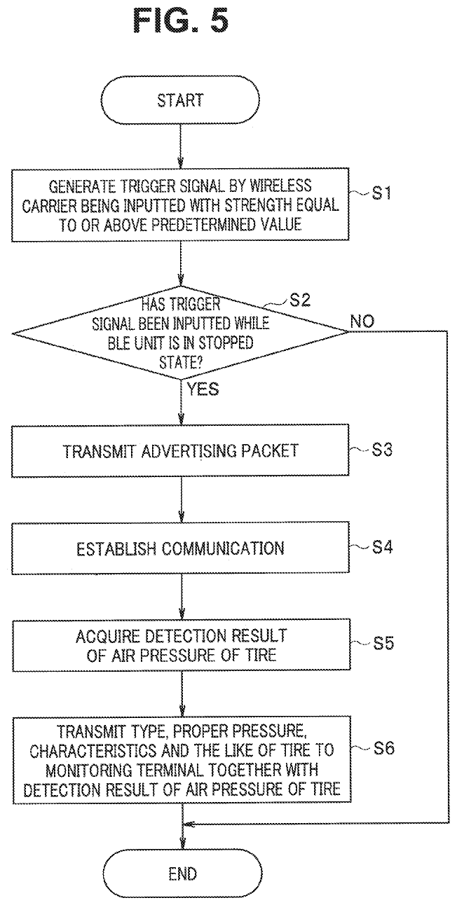

Next, a data transmission process in the tire communication apparatus will be described. FIG. 5 is a flowchart showing a flow of a data transmission process in the tire communication apparatus of the first embodiment.

The wireless wake-up control unit 11 generates a trigger signal by a wireless carrier being inputted with a strength equal to or above a predetermined value (S). The trigger signal is inputted to the BLE unit 13 from the wireless wake-up control unit 11 of the tire communication apparatus by bringing the monitoring terminal 20 close to the tire communication apparatus 10 in the state in which a wireless carrier is sent out from the wireless control unit 24 of the monitoring terminal 20.

The controller 12 of the BLE unit 13 judges whether or not the trigger signal has been inputted while the BLE unit 13 is in the stopped state (S2). If judging that the trigger signal has not been inputted while the BLE unit 13 is in the stopped state (S2: NO), the controller 12 ends the process. On the other hand, if judging that the trigger signal has been inputted while the BLE unit 13 is in the stopped state (S2: YES), the controller 12 transmits an advertising packet (S3). The monitoring terminal 20 that receives the advertising packet transmits a connection request to the tire communication apparatus 10. By the tire communication apparatus 10 receiving the connection request, communication is established between the tire communication apparatus 10 and the monitoring terminal 20 (S4).

When the communication with the monitoring terminal 20 is established, the controller 12 acquires a detection result of an air pressure of the tire 4 from the pressure sensor 14 (S5). The controller 12 transmits information about the type, proper pressure, characteristics and the like of the tire 4 to the monitoring terminal 20 together with the detection result of the air pressure of the tire 4 (S6) and ends the process. Note that the information about the type, proper pressure, characteristics and the like of the tire 4 is information that is registered with the tire communication apparatus 10 in advance according to the type of the tire 4 when the tire communication apparatus 10 is attached to the tire 4.

As described above, the tire communication apparatus 10 has the wireless wake-up control unit 11 configured to generate a trigger signal when receiving a wireless carrier of proximity wireless communication such as NFC. As a result, the tire communication apparatus 10 of the present embodiment can activate the BLE unit 13 at an arbitrary timing even if the BLE unit 13 is in the stopped state.

Furthermore, by configuring the wireless wake-up control unit 11 by proximity wireless communication such as NFC, the tire communication apparatus 10 can be caused to respond only to the monitoring terminal 20 that is intentionally brought close to the tire communication apparatus 10. Therefore, it is possible to limit a communication counterpart that performs communication by using the second communication method.

### Second Embodiment

Next, a second embodiment will be described.

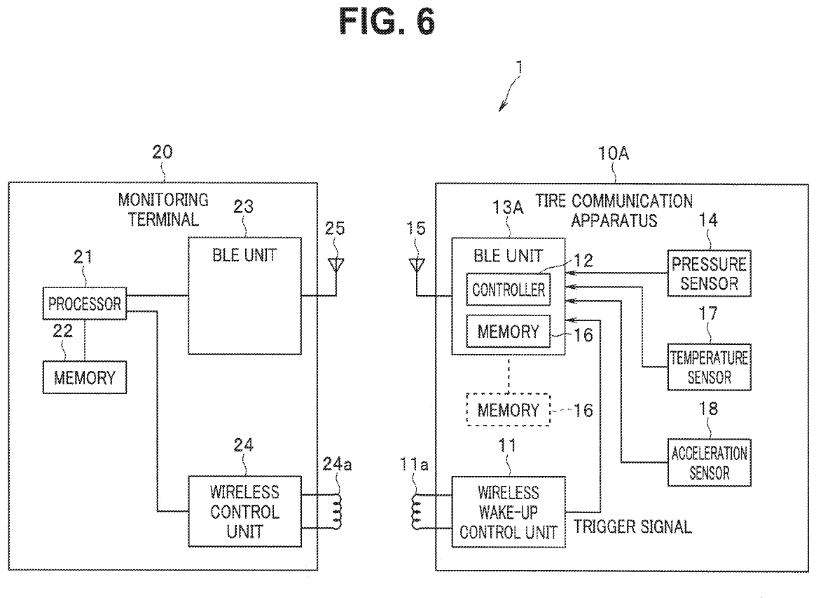

FIG. 6 is a block diagram showing a configuration of a tire communication system provided with a tire communication apparatus of the second embodiment. Note that, in FIG. 6, components similar to components of FIG. 2 are given the same reference numerals, and description will be omitted.

As shown in FIG. 6, a tire communication apparatus 10A of the second embodiment is provided with a BLE unit 13A instead of the BLE unit 13 of FIG. 2. The BLE unit 13A is configured having a memory 16 in addition to the controller 12. Note that though the memory 16 is provided inside the BLE unit 13A, the memory 16 may be provided outside the BLE unit 13A without being limited to the above. Furthermore, the tire communication apparatus 10A is configured by adding a temperature sensor 17 and an acceleration sensor 18 to the tire communication apparatus 10 of FIG. 2.

The temperature sensor 17 detects a temperature of the tire 4 and outputs a detection result to the BLE unit 13A. The acceleration sensor 18 detects an acceleration of the tire 4 and outputs a detection result to the BLE unit 13A. Note that the pressure sensor 14 detects an air pressure of the tire 4 and outputs a detection result to the BLE unit 13A similarly to the first embodiment.

The controller 12 of the BLE unit 13A accumulates (records) each of detection results inputted from the pressure sensor 14, the temperature sensor 17 and the acceleration sensor 18 in a state in which the BLE unit 13A is activated, for example, when the vehicle is traveling, into the memory 16. The controller 12 performs the recording of each detection result to the memory 16 at a predetermined interval (for example, every few seconds) while the vehicle is traveling. Note that the controller 12 can judge whether the vehicle is traveling or not depending on whether an acceleration of the tire 4 is detected by the acceleration sensor 18 or not.

When a trigger signal is inputted from the wireless wake-up control unit 11 while the BLE unit 13A is in the stopped state, the controller 12 of the BLE unit 13A establishes communication with the monitoring terminal 20. When the communication with the monitoring terminal 20 is established, the BLE unit 13A collectively transmits a plurality of detection results accumulated in the memory 16 to the monitoring terminal 20.

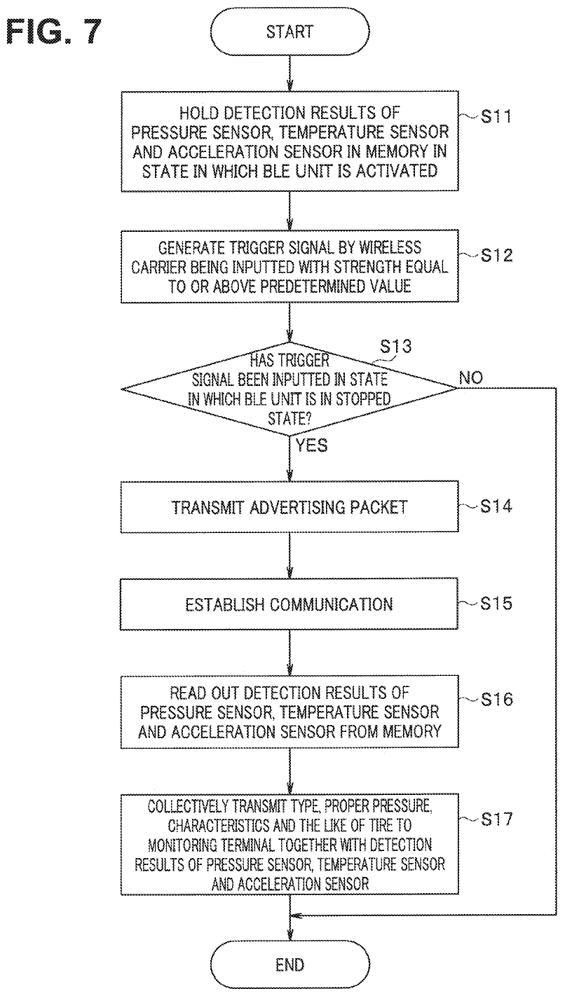

FIG. 7 is a flowchart showing a flow of a data transmission process in the tire communication apparatus of the second embodiment.

The controller 12 of the BLE unit 13A holds detection results of the pressure sensor 14, the temperature sensor 17 and the acceleration sensor 18 in the memory 16 in the state in which the BLE unit 13A is activated (S11). Detection of each of data by the pressure sensor 14, the temperature sensor 17 and the acceleration sensor 18 and recording of detection results to the memory 16 by the controller 12 are performed, for example, at a predetermined interval while the vehicle is traveling.

The wireless wake-up control unit 11 generates a trigger signal by a wireless carrier being inputted with a strength equal to or above a predetermined value (S12). The controller 12 judges whether or not the trigger signal has been inputted in a state in which the BLE unit 13A is stopped (S13). If judging that the trigger signal has not been inputted in the state in which the BLE unit 13A is stopped (S13: NO), the controller 12 ends the process. On the other hand, if judging that the trigger signal has been inputted in the state in which the BLE unit 13A is stopped (S13: YES), the controller 12 transmits an advertising packet (S14). The monitoring terminal 20 that receives the advertising packet transmits a connection request to the tire communication apparatus 10A. By the tire communication apparatus 10A receiving the connection request, communication is established between the tire communication apparatus 10A and the monitoring terminal 20 (S15).

When the communication with the monitoring terminal 20 is established, the controller 12 reads out the detection results of the pressure sensor 14, the temperature sensor 17 and the acceleration sensor 18 from the memory 16 (S16). The controller 12 collectively transmits the information about the type, proper pressure, characteristics and the like of the tire 4 to the monitoring terminal 20 together with the detection results of the pressure sensor 14, the temperature sensor 17 and the acceleration sensor 18 read out from the memory 16 (S17) and ends the process.

The user can grasp a use condition of the tire 4 in addition to information about an air pressure of the tire 4, from the information of the pressure sensor 14, the temperature sensor 17 and the acceleration sensor 18 transmitted to the monitoring terminal 20. By rasping the use condition of the tire 4, the user can select a tire type corresponding to the use condition. For example, if grasping that there are many opportunities to drive in a state in which a road surface is in a good condition, from the information of the temperature sensor 17 and the acceleration sensor 18, the user can select a tire excellent in fuel efficiency; and, if grasping that there are many opportunities to drive in a state in which a road surface is in a bad condition, the user can select a tire capable of suppressing vibration.

As described above, the tire communication apparatus 10A of the present embodiment can cause the BLE unit 13A to be activated at an arbitrary timing even in the state in which the BLE unit 13A is stopped, similarly to the first embodiment, and can provide various kinds of information about the tire 4 for the user.

Note that, for the steps in the flowcharts in the present specification, execution order may be changed, a plurality of steps may be simultaneously executed, or the steps may be executed in different order for each execution, unless it goes against natures of the steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A tire communication apparatus comprising:
a pressure sensor configured to detect an air pressure of a tire;
a first wireless control unit configured to, when receiving a wireless carrier sent out from a monitoring terminal by a first communication method, generate a trigger signal; and
a second wireless control unit activated by the trigger signal being inputted when the second wireless control unit is stopped, and configured to acquire a detection result of the air pressure of the tire from the pressure sensor and transmit the detection result to the monitoring terminal by a second communication method different from the first communication method.

2. The tire communication apparatus according to claim 1, comprising:
a temperature sensor configured to detect a temperature of the tire; and
an acceleration sensor configured to detect an acceleration of the tire.

3. The tire communication apparatus according to claim 2, comprising a memory configured to accumulate detection results of the pressure sensor, detection results of the temperature sensor and detection results of the acceleration sensor; wherein
when the trigger signal is inputted, the second wireless control unit transmits a plurality of the detection results accumulated in the memory to the monitoring terminal.

4. The tire communication apparatus according to claim 1, wherein, when being activated by the trigger signal, the second wireless control unit transmits a signal for communication establishment to the monitoring terminal at a predetermined interval.

5. The tire communication apparatus according to claim 1, wherein the first communication method is NFC communication, and the second communication method is BLE communication.
